(19) United States
(12) Patent Application Publication
(10) Pub. No.: US 2017/0286789 A1
(43) Pub. Date: Oct. 5, 2017

(54) BIOMETRIC AUTHORISED SMARTCARD AND METHOD FOR CONTROLLING A BIOMETRIC AUTHORISED SMARTCARD

(71) Applicant: Zwipe AS, Oslo (NO)

(72) Inventors: Jose Ignacio Wintergerst Lavin, Colorado Springs, CO (US); Steven Colussi, Colorado Springs, CO (US); Peter Robert Lowe, Peyton, CO (US)

(21) Appl. No.: 15/471,053

(22) Filed: Mar. 28, 2017

Related U.S. Application Data
(60) Provisional application No. 62/315,732, filed on Mar. 31, 2016.

(51) Int. Cl. G06K 9/00; G06K 19/077; G06Q 20/40; G06F 3/0346; G06Q 20/34

(52) U.S. Cl. CPC G06K 9/00912; G06K 9/0002; G06K 9/00926; G06F 3/0346; G06Q 20/34; G06Q 20/40145; G06Q 20/405; G06K 19/07703

(57) ABSTRACT

A biometric authorised smartcard 102 comprises: a biometric sensor 130; a control system 114, 128 for controlling operation of the smartcard 102; and a graphical user interface 18 for displaying alphanumeric information to a user of the smartcard 102. The smartcard 102 has one or more protected feature(s) that are accessible to a user identified via the biometric sensor 130 and the graphical user interface 18 displays information in response to interaction of the user with the biometric sensor 130. The information can be used to guide enrolment of a user via the biometric sensor 130 and/or to aid the interaction of the user with the biometric sensor 130 during biometric authorisation after enrolment.

### CROSS REFERENCE TO RELATED APPLICATION

This application is related to and claims the benefit of U.S. Provisional Patent Application Ser. No. 62/315,732, filed on 31 Mar. 2016, the contents of which are herein incorporated by reference in their entirety.

### TECHNICAL FIELD

The present invention relates to a biometric authorised smartcard and to a method for controlling a biometric authorised smartcard.

### BACKGROUND

Smartcards are becoming increasingly more widely used and include, for example access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID. These cards can interact with readers to communicate information in order to enable access, to authorise transactions and so on. Biometric authorised smartcards such as fingerprint authorised smartcards have been developed. Along with the addition of biometric security there is also a trend in increases to the number of features and capabilities of smartcards, including cards allowing for multiple modes of operation (e.g. as an access card or a bank card) as well as cards allowing for transactions in multiple different currencies or via multiple different accounts.

### BRIEF SUMMARY

Viewed from a first aspect the present invention provides a biometric authorised smartcard, the smartcard comprising: a biometric sensor; a control system for controlling operation of the smartcard; and a graphical user interface for displaying alphanumeric information to a user of the card; wherein the smartcard has one or more protected feature(s) that are accessible to a user identified via the biometric sensor; and wherein the graphical user interface displays information in response to interaction of the user with the biometric sensor. The information displayed to the user via graphical user interface may include information for guiding the user in relation to the use of the biometric sensor.

It has been realised that the added complexity of smartcards gives rise to a need for added capabilities in terms of interaction with the user, both in terms of communicating information and instructions from the user to the card, and also in terms of communicating information and instructions from the card to the user. By the use of a graphical user interface that displays information in response to interaction of the user with the biometric sensor it is possible to greatly enhance the user experience and to allow more effective and efficient utilisation of the features of the card. Combination of the graphical user interface with the use of a biometric sensor allows for various degrees of security for the information displayed on the graphical user interface, including the possibility of a requirement for biometric confirmation of the user's identity. In this way the advantages arising from the use of a graphical user interface can be combined with the advantages of added security from the biometric sensor.

The graphical user interface may display information that guides the user in relation to the use of the biometric sensor. Thus, the graphical user interface may display information providing feedback to the user in relation to their use of the sensor, such as feedback in relation to the position of the sensor and so on.

The graphical user interface may be used to display information relating to enrolment of a user with the card via the biometric sensor, as discussed in more detail below. It may alternatively or additionally be used to provide feedback to the user during the biometric authorisation process, for example information to aid the user in correct use of the biometric sensor. This is also discussed in more detail below.

The biometric sensor may be a fingerprint sensor. In the case of a fingerprint sensor the graphical user interface may display information that guides the user in relation to the use of the fingerprint sensor in various ways. For example, the graphical user interface may provide feedback on the positioning of the finger relative to the sensor and/or feedback on the pressure being applied to the sensor. This is useful during enrolment, when a user may be unfamiliar with operation of the sensor and may need more detailed instructions. In this way the graphical user interface can be used to reduce the need for video/internet guided enrolment or trained personnel to assist with correct enrolment since it is made easier to enrol directly with the smartcard using only the card itself. This feedback can alternatively or additionally be used to aid correct usage of the fingerprint sensor during later use of the smartcard for biometric authorisation.

The graphical user interface may be arranged to display alphanumeric symbols and/or pictograms, such as ASCII characters or the like. The graphical user interface may also be capable of displaying other types of information. The information displayed in response to interaction of the user with the biometric sensor may include information concerning the status of the smartcard, such as a power status, a current operating mode of the card, a status of communications with an external device, information concerning a biometric enrolment process, feedback relating to biometric authorisation, information relating to the protected features of the card and so on. In addition, the graphical user interface may optionally also be used to display information without the need for interaction with the biometric sensor, but instead in response to interaction with other inputs or sensors of the smartcard.

When the graphical user interface is showing information for guiding the user in relation to the use of the biometric sensor then this may include symbols relating to the position of the sensor. For example arrows or other symbols may be used to indicate that a repositioning is recommended. In the example of a fingerprint sensor then symbols may be used to guide the user's finger until the sensing area is able to receive a clear image for the whole sensing area. These symbols may guide position as well as the pressure applied.

In the case where the information displayed by the card should be kept secure then the interaction with the biometric sensor may require confirmation of the identity of the user via biometric authorisation before the information is displayed. Although there is added security for the information displayed by the card merely from the requirement for interaction with the biometric sensor, it is clearly advantageous for at least the more secure types of information if the interaction also serves to confirm that the user is an authorised user. In some examples a biometric authorisation may be required for all use of the graphical user interface once the user has been enrolled. In other cases the biometric authorisation may be required only for information designated as secure, such as information relation to protected features of the card, and other information can be displayed without full biometric authorisation, such as the power status.

It will hence be appreciated that the interaction with the biometric sensor may include interaction sufficient to provide biometric authorisation, or it may be only an interaction sufficient to activate the biometric sensor, i.e. to be sensed as a presence of a user. Typically the interaction with the biometric sensor will be a physical interaction requiring physical contact or close proximity of the user with the smartcard. In the case where the interaction is not sufficient to provide biometric authorisation then the interaction may include the user touching the biometric sensor, or a sequence of touches such as tapping the sensor. The interaction with the biometric sensor may also be combined with interaction via other inputs or sensors of the smartcard, and hence a combination of interactions with the card may be required for the graphical user interface to display certain types of information.

The graphical user interface may display a power status in response to interactions of the user with the biometric sensor and optionally also with other inputs/sensors of the card. The power status may include an indication of if the card is harvesting power when the card includes a power harvesting capability and/or it may include a battery power level when the card uses a battery. Access to information on power status may be permitted without full biometric authorisation.

An operating mode of the card may be displayed on the graphical user interface in response to interactions of the user with the biometric sensor and optionally also with other inputs/sensors of the card. Possible types of features that are considered as operating modes of the card are discussed further below. In some cases the display of this type of information may require biometric authorisation.

The information presented on the graphical user interface may include information relating to communication between the card and an external system being displayed on the graphical user interface in response to interactions of the user with the biometric sensor and optionally also with other inputs/sensors of the card. The information may hence include an indication of whether or not communication with an external system has been established and if data is being uploaded or downloaded to or from the smartcard. The information may also include the type of communication where different types of communication are possible. This can also be considered as an operating mode of the card as discussed below.

The information displayed via the graphical user interface may include details relating to protected features of the smartcard, and advantageously this is only displayed after a biometric authorisation confirms that the user is an authorised user. For some high security applications any use of the display may itself be a protected feature. Other examples of protected features are set out below, and can include one or more of one-time-passwords, access information relating to secure areas, information on past usage of the card, and/or information concerning financial transactions such as account balances, recent transactions, account numbers or parts thereof or security codes, for example the three digit code found on credit cards and commonly used for added security in relation to telephone or internet transactions.

Preferably, sensitive information is only displayed on the card via the graphical user interface and is not otherwise visible. Thus, in one particular example the smartcard is a bank card used in financial transactions and one or more of the card number(s) or parts thereof are not visible on the card aside from via the graphical user interface, and optionally only after biometric authorisation. This means that it is not possible to fraudulently use the card based on visible information on the card. Gathering of information via cameras or the like and then carrying out fraudulent transactions is no longer possible. Moreover, when a biometric authorisation is required then fraudulent use of the card is not possible even when the card is in the possession of the potential fraudster.

The biometric sensor may be a fingerprint sensor and in this case the interaction with the sensor may include one or more of a stationary contact with the sensor, a moving contact with the sensor, a time period of contact with the sensor, a direction of movement of contact with the sensor, a number of contacts with the sensor, or a time period where there is no contact with the sensor (i.e. a time period between contacts). Access to some types of information via the graphical user interface may require a combination of different actions, which may include a sequence of actions on the fingerprint sensor and/or at least one action on the fingerprint sensor in combination with at least one action via another input or sensor, such as via an accelerometer for example.

The fingerprint sensor may be embedded into the card. With this feature the authorised user may initially enrol their fingerprint onto the actual card, and may then be required to place their finger or thumb on the fingerprint sensor in order to authorise some or all uses of the card. A fingerprint matching algorithm on the control system may be used to identify a fingerprint match between an enrolled user and a fingerprint sensed by the fingerprint sensor.

As noted above, the graphical user interface may be used to assist enrolment of a user with the smartcard via the biometric sensor. This can include providing basic information to the user, such as whether or not registration of biometric data has been successful, and if they should repeat the registration process. Many biometric systems rely on having multiple confirmed sets of data upon enrolment in order to establish a template for later comparison when the user seeks to access the protected features of the smartcard using the biometric authorisation system. The enrolment assistance may also include providing guidance to the user to aid their physical interaction with the biometric sensor during enrolment as noted above.

The interaction with the fingerprint sensor that can be used to activate display of information via the graphical user interface can be a biometric authorisation as explained above, but for information deemed not to require biometric security it may be any contact detectable via the fingerprint sensor of the device. The nature of fingerprint sensors means that they are arranged to identify contact with the skin and so the contact may be a contact of the skin, for example contact with a fingertip or thumbtip. An interaction in the form of stationary contact detected by the fingerprint sensor may include a detection of the presence of a contact, as distinct from the absence of a contact. Alternatively, the interaction(s) detected by the fingerprint sensor may include a detection of characteristics of the contact that allow for differentiation between two different contacts, e.g. a difference between one person's thumb contact and another person's thumb contact, but are not sufficiently detailed or complex for full fingerprint authorisation.

An interaction in the form of a moving contact detected by the fingerprint sensor may include a detection of the direction of movement and/or a speed of the movement. The direction may be identified relative to one or more axes of the smartcard. For example, the control system may be arranged to distinguish between a contact moving parallel with the long side of the card and a contact moving parallel with the short side of the card. The action(s) may include a sequence with parallel and/or perpendicular movements, or more complex movements defined by the user, such as a rotating contact or a circular movement.

Whether the fingerprint sensor is used to simply detect the presence of a contact or to detect more complex characteristics the interaction detected by the fingerprint sensor may include a time period of one or more contacts, a number of contacts and/or the spacing in between contacts, similar to codes such as Morse code, for example.

The interaction may include or consist of a code input by a sequence of stationary or moving contacts with the biometric sensor. In this way there can be added security for display of certain types of information via the graphical user interface but without the use of full biometric authorisation. This could allow some types of use of the smartcard whilst it is not in the possession of a biometrically authorised user.

The interactions with the biometric sensor may optionally be combined with interactions with one or more further sensor of the smartcard. Additional sensors on the smartcard may include one or more button, capacitive sensor or accelerometer, for example. Two different types of biometric sensor could be used.

Thus, the smartcard may comprise an accelerometer for sensing movements of the device, wherein the control system is arranged to identify movements of the smartcard based on the output of the accelerometer, and wherein the information displayed on the graphical user interface may be accessed by or controlled by a combination of one or more action(s) detected via the biometric sensor as well as a movement sensed by the accelerometer.

The various possible ways for the user to interact with the smartcard, including interaction(s) with the biometric sensor, as well as optionally movements detected by an accelerometer and/or inputs via buttons or other sensors may be used as instructions for the control system to switch between different modes of multiple operating modes of the smartcard. As noted above, the graphical user interface may display information concerning the operating mode of the card.

The movements sensed by the accelerometer may include rotation of the smartcard in one or more directions (clockwise/anticlockwise) and/or in one or more than one axis of rotation, translation of the smartcard in one or more directions (forward/backward) and along one or more axis, and/or accelerations in one or more directions (forward/backward) and along one or more axis as well as jerk or impulses in one or more directions (forward/backward) and along one or more axis. Combinations of these movements may also be detected, for example a “flick” motion including a combination of translation and acceleration/deceleration to characterise the movement detected by the accelerometer.

Rotations of the smartcard sensed by the accelerometer may include changes in orientation of the smartcard, for example from portrait to landscape orientation or turning the card over. The rotations may include 90 degree turns, 180 degree turns, 270 degree turns or 360 degree turns, or intervening values, in any direction.

Translational movements may include waving motions, optionally in combination with acceleration/deceleration as with a flicking type motion, or a tapping motion.

The control system may be arranged to identify the movements of the smartcard based on the output of the accelerometer, and use this to prompt the display of information on the graphical user interface and/or to change the operating mode of the device in response to pre-set movements. The pre-set movements may include any or all movements discussed above. In addition, the control system may determine the length of a time period without motion, i.e. a time period indicative of no active usage of the smartcard, and this may also be used to change the operating mode of the smartcard or to prompt a change to the information displayed on the graphical user interface. For example the graphical user interface may be inactivated after a period without motion.

The control system may be arranged to identify repeated interactions with the biometric sensor and/or movements detected via an accelerometer, or sequences of movements, such as a double tap, or a translational movement followed by a rotation such as a sliding and twisting motion. Advantageously, the smartcard may be arranged to allow the user to set their own movements and or combinations of movements and interactions with the biometric sensor. For example the control system may have a learn mode where a combination of movements/interactions by the user can be taught to the control system and then allocated to a specific change in the operating mode of the smartcard or to prompt display of a particular type of information on the graphical user interface. This can provide for increased security by the use of movements that may be unique to each individual.

Thus, a graphical user interface can be combined with the use of the biometric sensor for biometric authorisation and also using other interactions with the biometric sensor, or another sensor such as an accelerometer. This means that the smartcard has the capability of improved security, by requiring biometric authorisation for access to information that is deemed secure, and also allows for simpler non-biometric interactions with the card in order to control the display of less secure information as well as to control other aspects of the card such as the mode of operation. The smartcard can convey information of varying levels of security with appropriate security protection, and it can increase security compared to traditional bank cards for information traditionally shown on the face of the card, such as the three digit security code. The interaction with the biometric sensor can influence the information displayed on the graphical user interface and as well as this the graphical user interface can be used to guide the interaction of the user with the biometric sensor, for example by providing feedback on the position and pressure of a finger on a fingerprint sensor.

The graphical user interface may for example comprise an LED or LCD display. So-called ‘electronic paper’ displays may be used, such as electrophoretic or electro-wetting displays. These displays can have very low power consumption and the ability to display relatively complex symbols.

The graphical user interface may be a two dimensional display with an area of 15 mm² to 350 mm². The width of the display might be from 5 mm up to 70 mm and the height of the display might be from 3 mm up to 50 mm. An example of a suitable display is a TFT active matrix electrophoretic display such as the E-ink GDP015WG1 display as supplied by Dalian Good Display Co., Ltd. of China. This display has a screen size of 31.8(H)×37.32(V) mm with 200×200 pixels.

In some example embodiments the graphical user interface has a height similar to the height of the numbers on the front face of a conventional credit card, hence about 5 mm, and a width that is able to show multiple symbols with a similar size to the numbers on a conventional credit card, for example a width of 15-35 mm allowing four to eight numbers to be shown. The size of the display can be set depending on the information to be displayed and on the power available to operate the display. A greater width may be used if the smartcard can provide sufficient power to a larger sized graphical user interface without excessive drain on the battery or other power source of the smartcard.

The graphical user interface may include multiple separate displays, which may each be a display as described above. The multiple displays might be used for differing purposes and/or in different operating modes of the smartcard. The graphical user interface could include a single display with a split display area, so that a larger or smaller area of the display can be activated depending on the information to be displayed and/or on the power available to operate the display. The display may be powered by a battery and/or by harvested power. There may be a display that is only utilised when harvested power is available in order to avoid the need for an on-board power source and/or to minimise the drain on power stored in the on-board power source. One advantageous arrangement for a smartcard may include a larger display, or a larger area of a display, that is active when the smartcard is being powered using harvested power from a card reader, and a smaller display, or a smaller area of a display, that is active when the smartcard is being powered by an on-board battery without any harvested power being available.

It is preferred for the graphical user interface to be able to convey information to the user via alphanumeric symbols. For example the graphical user interface may be arranged to show multiple ASCII characters. The graphical user interface may be controlled to display a scrolling sequence of symbols. In this way it is possible to show a longer message than can be accommodated on the graphical user interface at a single time.

In the case of a smartcard with the same size as a conventional bank card the graphical user interface may be located on the face of the smartcard where the bank card numbers are conventionally located. Hence the graphical user interface may be at the lower part of the front face of the card. Alternatively, the graphical user interface may be on the reverse side of the card, for example in a similar location or at a location where the signature strip would normally be found.

The smartcard may be capable of wireless communication, such as using RFID and/or NFC communication. Alternatively or additionally the smartcard may comprise a contact connection, for example via a contact pad or the like such as those used for “chip and pin” cards. In various embodiments, the smartcard may be arranged for both wireless communication and contact communication. The graphical user interface may indicate when communication with external devices is in progress and/or it may indicate which communication protocol is in use when several possibilities are available on the smartcard.

The operating modes of the smartcard that are controlled by the interaction of the user with the smartcard may be related to a high level function, for example turning the smartcard on or off, activating secure aspects of the smartcard such as contactless payment, or changing the basic functionality of the smartcard for example by switching between operating as an access card, a payment card, or a transportation smartcard, switching between different accounts of the same type (e.g. two bank accounts) and so on.

Alternatively or additionally the operating modes of the smartcard that are controlled by interaction of the user with the smartcard may concern more specific functionalities of the smartcard, for example switching between communications protocols (such as blue tooth, wife, NFC) and/or activating a communication protocol, activating the display or obtaining an output from the device, such as a one-time-password or the like.

The operating modes of the smartcard that are controlled by interaction of the user with the smartcard may include prompting the device to automatically perform a standard operation of the smartcard. Examples of such standard operations might include a pre-set cash withdrawal in response to a specific movement during or prior to communication with an ATM, entering into a learning or set-up mode, PIN activation of the smartcard (i.e. movements used in place of a PIN entry via a keypad on an external card reader), sending a message to a contactless reader or a smartphone (e.g. via NFC) and so on.

The graphical user interface may optionally include an indication of what operating mode is activated or is in use. The control system may be arranged to allow for the user to specify which interactions (including combinations of different interactions and/or movements) should activate particular operating modes, and/or to display particular information on the graphical user interface. The control system may use different movements for each one of a set of operating modes, or alternatively it may cycle through the operating modes of a set of operating modes in response to a repeated interaction of the user with the smartcard.

Identification of an authorised user via the biometric sensor is used to activate one or more protected feature(s), which may include operating modes of the card, a payment or withdrawal with a payment/bank card, or access to secure areas when the smartcard is an access card. The protected features of the smartcard may be any features requiring the security of a biometric authorisation. This may include one or more of: enabling communication of the smartcard with an external system, for example contactless communication; sending certain types of data to an external system; allowing access to a secure element of the smartcard, such as a secure element used for financial transactions, permitting a transaction between the smartcard and an external system; enabling access to data stored on the smartcard and so on. With the use of a graphical user interface as described above the protected features may also include access to some or all types of information via the graphical user interface.

The control system may include a processing unit associated with the biometric sensor for performing a biometric matching process to confirm the identity of the user via biometric data stored on the card. The control system may include multiple interconnected processors that together for a control system having overall control of all functions of the smartcard. There may hence be a processing unit associated with the biometric sensor as well as a separate processor for controlling higher level functions of the card, such as a control processor for controlling basic functions of the device, such as communication with other devices (e.g. via contactless technologies), activation and control of receivers/transmitters, activation and control of the secure element. The various processors could be embodied in separate hardware elements, or could be combined into a single hardware element, possibly with separate software modules. If there are multiple processors then it is preferred for the processing unit of the biometric sensor to communicate with the other processor(s) of the control system using encrypted data. The control system may include a memory for storing enrolled biometric data.

A secure element may be included in the smartcard as a part of the control system and/or may be connected to the control system, preferably with encrypted communication between the secure element and the control system. The secure element may be a secure element for financial transactions as used, for example, on known bank cards.

It is preferred for the smartcard to be arranged so that it is impossible to extract the data used for identifying users via the biometric authorisation. The transmission of this type of data outside of the smartcard is considered to be one of the biggest risks to the security of the smartcard's biometric protection.

To avoid any need for communication of the biometric data outside of the smartcard then it may be able to self-enrol, i.e. the smartcard may arranged to enrol an authorised user by obtaining biometric data via the biometric sensor, and preferably is not capable of using biometric data enrolled via external devices.

This also has advantages arising from the fact that the same sensor with the same geometry is used for the enrolment as for the biometric authorisation. The biometric data can be obtained more consistently in this way compared to the case where a different sensor on a different device is used for enrolment. With biometrics and in particular with fingerprints, one problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing around each fingerprint sensor must be carefully designed to guide the finger in a consistent manner each time it is read by any one of multiple sensors. If a fingerprint is scanned with a number of different terminals, each one being slightly different, then errors can occur in the reading of the fingerprint. Conversely, if the same fingerprint sensor is used every time then the likelihood of such errors occurring is reduced. The incidence of errors in the biometric data can be further enhanced by the use of guided enrolment using information and feedback to the user provided via the graphical user interface as explained above.

The control system may have an enrolment mode in which a user may enrol their biometric data via the biometric sensor, with the biometric data generated during enrolment being stored on a memory. The enrolment mode may use guided enrolment as explained above. The control system may be in the enrolment mode when the smartcard is first provided to the user, so that the user can immediately enrol their biometric data. The first enrolled user may be provided with the ability to later prompt an enrolment mode for subsequent users to be added, for example via input on an input device of the smartcard after identification has been confirmed. Alternatively or additionally it may be possible to prompt the enrolment mode of the control system via outside means, such as via interaction between the smartcard and a secure external system, which may be a secure external system controlled by the manufacturer or by another authorised entity.

The smartcard may be any one of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Viewed from a second aspect, the invention provides a method for controlling a biometric authorised smartcard, the smartcard comprising: a biometric sensor; a control system for controlling operation of the smartcard; and a graphical user interface for conveying graphical information to a user of the card; wherein method includes controlling access to one or more protected feature(s) of the smartcard by identifying authorised users via the biometric sensor; and displaying information on the graphical user interface in response to interaction of the user with the biometric sensor.

The method may include using the graphical user interface to display information to guide enrolment of a user via the biometric sensor and/or to aid the interaction of the user with the biometric sensor during biometric authorisation after enrolment.

The method may include use of a smartcard with features as discussed above in relation to the first aspect. Thus, the information that is displayed may be as described above and/or the interaction of the user with the biometric sensor and/or with other inputs or sensors of the smartcard may be as discussed above. The method may include displaying information of certain types only after biometric authorisation via the interaction of the user with the biometric sensor, for example the display of the three digit security code for a bank card. In yet a further aspect, the present invention may also provide a computer programme product comprising instructions that, when executed on a control system in a smartcard as described above, will cause the control system to: control access to one or more protected feature(s) of the smartcard by identifying authorised users via the biometric sensor; and to display information on the graphical user interface in response to interaction of the user with the biometric sensor. The instructions may be arranged to cause the processor to operate in accordance with any or all of the optional and preferred features discussed above. The instructions may cause the control system to use the graphical user interface to display information to guide enrolment of a user via the biometric sensor and/or to aid the interaction of the user with the biometric sensor during biometric authorisation after enrolment.

### BRIEF DESCRIPTION OF THE DRAWINGS

Certain preferred embodiments on the present invention will now be described in greater detail, by way of example only and with reference to the accompanying drawings, in which:

FIG. 1 illustrates a circuit for a smartcard incorporating a graphical user interface and biometric authorisation via a fingerprint scanner;

FIG. 2 illustrates an example smartcard having an external housing; and

FIG. 3 illustrates an example smartcard with a laminated card body.

### DETAILED DESCRIPTION

By way of example the invention is described in the context of a fingerprint authorised smartcard that includes contactless technology and uses power harvested from the card reader. These features are envisaged to be advantageous features of one application of the proposed graphical user interface feature, but are not seen as essential features. The smartcard may hence alternatively use a physical contact and/or include a battery providing internal power, for example. The graphical user interface may also be implemented in smartcards with non-fingerprint biometric sensors.

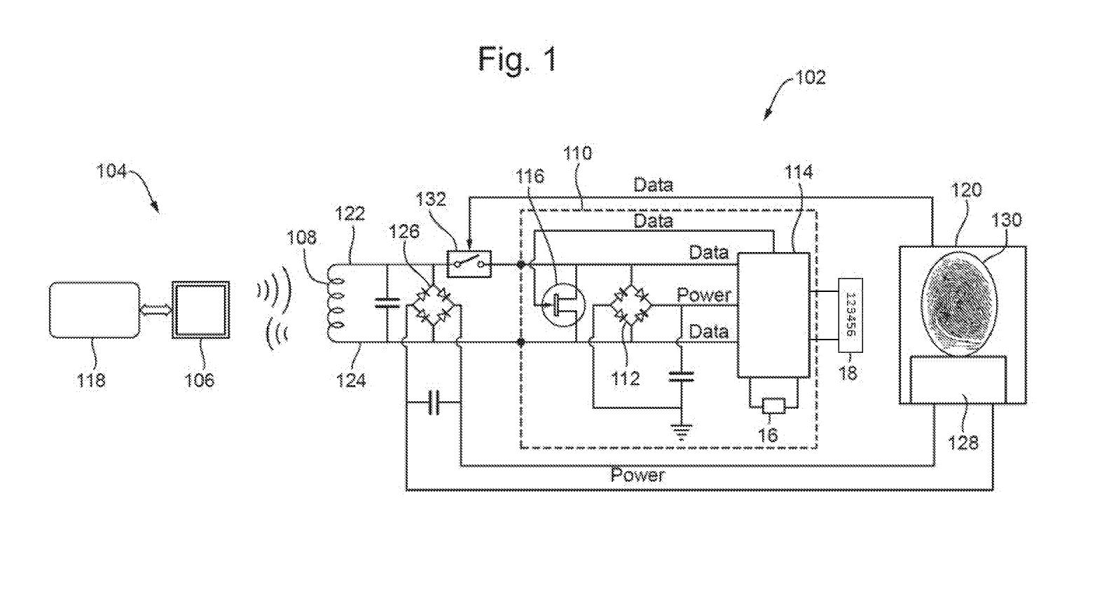

FIG. 1 shows the architecture of a smartcard 102 that has biometric authorisation via a fingerprint sensor 130 and includes a graphical user interface 18 for displaying alphanumeric information and optionally other forms of information to the user of the smartcard 102.

The smartcard 102 interacts with a powered card reader 104 that transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the sensor 104. This type of signalling is known as backscatter modulation and is characterised by the fact that the sensor 104 is used to power the return message to itself.

A graphical user interface 18 is connected to the processor 114, with the processor being able to control the display of the graphical user interface. By way of example the graphical user interface 18 may be provided by the E-ink GDP015WG1 display as supplied by Dalian Good Display Co., Ltd. of China, which is a TFT active matrix electrophoretic display with a screen size of about 32 mm by 37 mm and 200 by 200 pixels. This display can show ASCII characters or simple pictographic icons in order to convey information to the user. Scrolling of the characters on the graphical user interface 18 can be used to allow a longer string of characters to be shown than can fit on the graphical user interface 18 at any one time, such as a long number or a written message to the user.

The graphical user interface 18 can be controlled by the processor 114 in conventional fashion. Optionally the graphical user interface 18 may have its own processor, which would hence form a part of the broader control system of the smartcard 102 and would be linked to the processor 114, preferably using an encrypted connection. The graphical user interface 18 may be used only when power is being harvested from the powered card reader 104, or alternatively the smartcard 102 may be additionally provided with a battery (not shown in the Figures) allowing for the graphical user interface 18 to be used at any time.

An accelerometer 16 is connected in an appropriate way to the processor 114. The accelerometer 16 can be a Tri-axis Digital Accelerometer as provided by Kionix, Inc. of Ithaca, N.Y., USA and in this example it is the Kionix KXCJB-1041 accelerometer 16. The accelerometer 16 senses movements of the card and provides an output signal to the processor 114, which is arranged to detect and identify movements of the accelerometer 16, such as movements that are associated with required operating modes on the card as discussed below. Again, the accelerometer 16 may be used only when power is being harvested from the powered card reader 104, or alternatively the smartcard 102 may be additionally provided with a battery (not shown in the Figures) allowing for the accelerometer 16 to be used at any time.

The smartcard further includes a fingerprint authentication engine 120 including a fingerprint processor 128 and a fingerprint sensor 130. This allows for enrolment and authorisation via fingerprint identification. The fingerprint processor 128 and the processor 114 that controls the communication chip 110 together form a control system for the device, optionally with an additional separate processor for the graphical user interface 18 as noted above. The various processors could be implemented as different software modules on the same hardware, although separate hardware could also be used.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and then supplied to the fingerprint authentication engine 120.

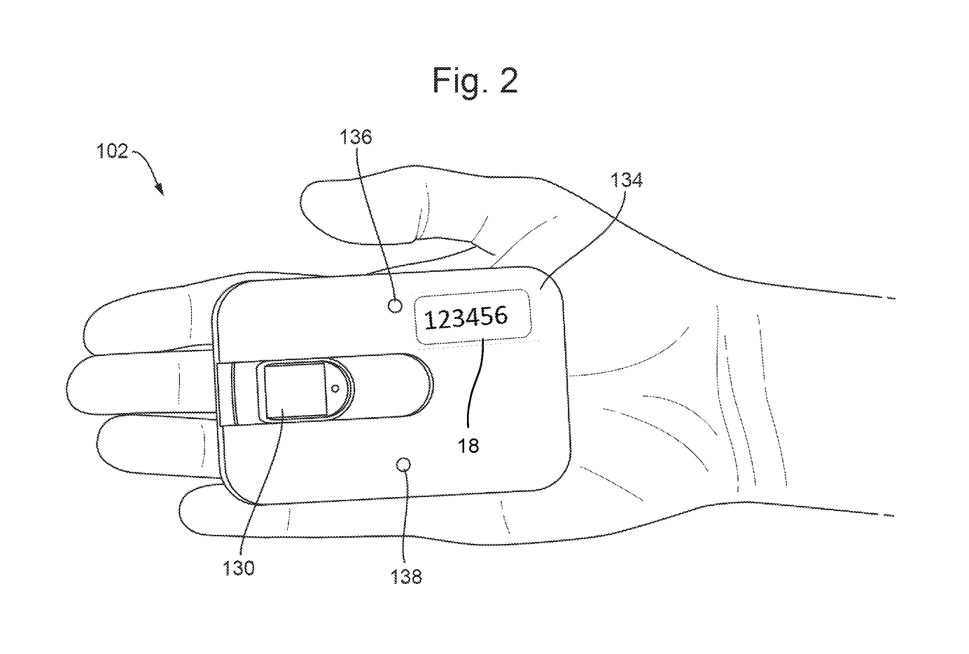

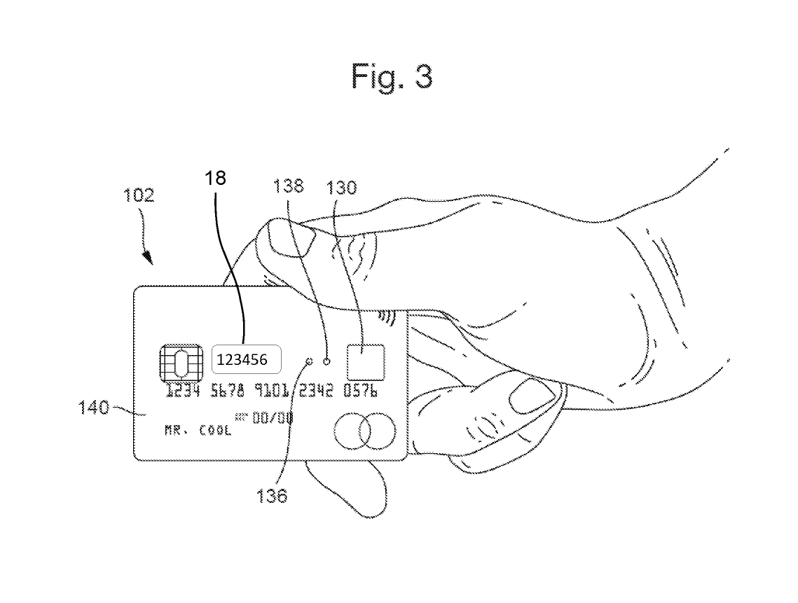

The fingerprint sensor 130 of the fingerprint authorisation engine, which can be an area fingerprint sensor 130, may be mounted on a card housing 134 as shown in FIG. 2 or fitted so as to be exposed from a laminated card body 140 as shown in FIG. 3. The card housing 134 or the laminated body 140 encases all of the components of FIG. 1, and is sized similarly to conventional smartcards. The fingerprint authentication engine 120 can be passive, and hence powered only by the voltage output from the antenna 108, although the smartcard 102 may also include a battery as mentioned above. The battery can power the fingerprint authentication engine 120 as well as other processors and user interfaces such as the graphical user interface 18, the accelerometer 16 and the LEDs 136, 138. The processor 128 comprises a microprocessor that is chosen to be of very low power and very high speed, so as to be able to perform fingerprint matching in a reasonable time.

The fingerprint authentication engine 120 is arranged to scan a finger or thumb presented to the fingerprint sensor 130 and to compare the scanned fingerprint of the finger or thumb to pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second.

When a fingerprint match is determined and/or when appropriate movements are detected via the accelerometer 16, then the processor 114 takes appropriate actions depending on its programming. In this example the fingerprint authorisation process is used to authorise the use of the smartcard 104 with the contactless card reader 104. Thus, the communication chip 110 is authorised to transmit a signal to the card reader 104 when a fingerprint match is made. The communication chip 110 transmits the signal by backscatter modulation, in the same manner as the conventional communication chip 110. The card may provide an indication of successful authorisation using a suitable indicator, such as a first LED 136 or the graphical user interface 18.

The fingerprint processor 128 and the processor 114 can also receive an indication of a non-fingerprint interaction with the fingerprint sensor 130, which can include any action detectable via the fingerprint sensor 130 as discussed above. The interaction of the user with the card via the fingerprint sensor 130 can be used to prompt and/or control information shown on the graphical user interface 18 and also may be used to allow the user to control the smartcard 102 by switching between different operating modes of the smartcard 102.

In some circumstances, the owner of the fingerprint smartcard 102 may suffer an injury resulting in damage to the finger that has been enrolled on the card 102. This damage might, for example, be a scar on the part of the finger that is being evaluated. Such damage can mean that the owner will not be authorised by the card 102 since a fingerprint match is not made. In this event the processor 114 may prompt the user for a back-up identification/authorisation check via an alternative interaction with the smartcard 102, which in this case includes one or more action(s) detected via the fingerprint sensor 130 and also optionally actions detected via other sensors, such as the accelerometer 16. The card may prompt the user to use a back-up identification/authorisation using a suitable indicator, such as a second LED 138 or the graphical user interface 18. It is preferred for the non-fingerprint authorisation to require a sequence of interactions with the card by the user, this sequence being pre-set by the user. The pre-set sequence for non-fingerprint authorisation may be set when the user enrols with the card 102. The user can hence have a non-fingerprint authorisation in the form of a “password” entered using non-fingerprint interactions with the card to be used in the event that the fingerprint authorisation fails. The same type of non-fingerprint authorisation can be used in the event that a user is unable or unwilling to enrol with the card 102 via the fingerprint sensor 130.

Thus, as well as allowing communication via the circuit 110 with the card reader 104 in response to a fingerprint authorisation via the fingerprint sensor 130 and fingerprint processor 128 the processor 114 may also be arranged to allow such communication in response to a non-fingerprint authorisation.

When a non-fingerprint authorisation is used the card 102 could be arranged to be used as normal, or it could be provided with a degraded mode in which fewer operating modes or fewer features of the card 102 are enabled. For example, if the smartcard 102 can act as a bank card then the non-fingerprint authorisation might allow for transactions with a maximum spending limit lower than the usual maximum limit for the card 102.

The processor 114 receives the output from the accelerometer 16 and this allows the processor 114 to determine what movements of the smart card 102 have been made. The processor 114 identifies pre-set movements and other interactions of the user with the card that are linked with required changes to the operating mode of the smartcard 102. As discussed above, the movements may include any type of or combination of rotation, translation, acceleration, impulse and other movements detectable by the accelerometer 16. The other interactions of the user with the card may include interactions detected via the fingerprint sensor 130, such as taps, swipes and so on as discussed above.

The operating modes that the processor 114 activates or switches to in response to an identified movement associated with the require change in operating mode may include any mode of operation as discussed above, including turning the card on or off, activating secure aspects of the card 102 such as contactless payment, or changing the basic functionality of the card 102 for example by switching between operating as an access card, a payment card, a transportation smartcard, switching between different accounts of the same type (e.g. two bank accounts), switching between communications protocols (such as blue tooth, Wifi, NFC) and/or activating a communication protocol, activating a display such as an LCD or LED display, obtaining an output from the smartcard 102, such as a one-time-password or the like, or prompting the card 102 to automatically perform a standard operation of the smartcard 102.

The graphical user interface 18 displays information to the user in response to data set from the processor 114. The graphical user interface 18 can be located on the card housing 134 as shown in FIG. 2 or fitted so as to be exposed from a laminated card body 140 as shown in FIG. 3. The processor 114 is arranged to control the graphical user interface 18 based on interaction of the user with the biometric sensor, i.e. the fingerprint sensor 130 in this example, and optionally also based on other interactions of the user with the smartcard 102, such as via movements detected with the accelerometer 16. The graphical user interface 18 may for example display certain types of less sensitive information when prompted via a tap on the fingerprint sensor 130, such as displaying a power status indicating if the device is harvesting power or not and/or indicating the level of power stored in the battery. In addition, the graphical user interface 18 may display more sensitive or secure information only after the identity of the user has been checked via fingerprint authorisation using the fingerprint sensor and processing unit 128. This more sensitive information may be a card number of the smartcard 102 or a part thereof, or the three digit security code for the smartcard 102 when it is a bank card.

During use of the fingerprint sensor 130 to confirm the identity of the user the graphical user interface 18 displays feedback to the user on their interaction with the fingerprint sensor 130. Thus, the graphical user interface 18 may show when the pressure of the finger on the fingerprint sensor 130 is too high or too low, and it may prompt the user to reposition their finger if it is not correctly located, for example if the finger is not centred on the area of a fingerprint area sensor 130. The graphical user interface 18, or optionally other display devices on the smartcard 102 such as the LEDs 136, 138 may indicate when authorisation has been successful or unsuccessful.

The processor 114 has an enrolment mode, which may be activated upon first use of the smartcard 102. In the enrolment mode the user is prompted to enrol their fingerprint data via the fingerprint sensor 130. This can require a repeated scan of the fingerprint via the fingerprint sensor 130 so that the fingerprint processor 128 can build up appropriate fingerprint data, such as a fingerprint template. The graphical user interface 18 is used to provide feedback and guidance to the user during enrolment. This can include feedback on the pressure and/or location of the user's finger on the fingerprint sensor 130 as noted above, as well as simple instructions such as “ready for enrolment,”, “place finger on sensor”, “scanning”, “remove finger”, “repeat fingerprint scan”, “enrolment completed” and so on. After a successful or an unsuccessful enrolment of fingerprint data the user may be prompted to enter a non-fingerprint authorisation. This could be optional in the case of a successful fingerprint enrolment, or may be compulsory if the fingerprint enrolment was not successful. The non-fingerprint authorisation includes a sequence of interactions with the smartcard 102 including at least one action by the user that is detected via the fingerprint sensor 130. The processor 114 can keep a record of these interactions in a memory, and it is arranged to provide at least partial authorisation to use the functions of the card in the event that the non-fingerprint authorisation is provided by the user.

The processor 114 can have a learn mode to allow for the user to specify which actions (including combinations of actions/interactions) should activate particular operating modes whilst the smartcard 102 is in use. This type of control of the smartcard 102 might be enabled only after a successful fingerprint or non-fingerprint authorisation. In the learn mode the processor 114 prompts the user to make the desired sequence of actions, and to repeat the movements for a predetermined set of times. These movements are then allocated to the required operating mode or to the non-fingerprint authorisation. With this latter feature the learn mode can allow for the sequence of movements used for the non-fingerprint authorisation to be changed by the user in the same way that a traditional PIN can be changed.

1. A biometric authorised smartcard, the smartcard comprising:
a biometric sensor;
a control system for controlling operation of the smartcard; and
a graphical user interface for conveying alphanumeric information to a user of the card;
wherein the smartcard has one or more protected feature(s) that are accessible to a user identified via the biometric sensor; and
wherein the graphical user interface displays information in response to interaction of the user with the biometric sensor, with the information displayed including information for guiding the user in relation to the use of the biometric sensor.

2. A biometric authorised smartcard as claimed in claim 1, wherein the information displayed in response to interaction of the user with the biometric sensor includes one or more of: information concerning the status of the smartcard, such as a power status, a current operating mode of the card, a status of communications with an external device, information concerning a biometric enrolment process, feedback relating to biometric authorisation, and/or information relating to the protected features of the card.

3. A biometric authorised smartcard as claimed in claim 1, wherein the graphical user interface is used to display information relating to guidance to the user to aid their physical interaction with the biometric sensor.

4. A biometric authorised smartcard as claimed in claim 3, wherein the graphical user interface is used to display information relating to enrolment of a user with the smartcard via the biometric sensor, the information including instructions to the user and feedback to the user to aid correct use of the sensor.

5. A biometric authorised smartcard as claimed in claim 3, wherein the graphical user interface is used to display information relating to feedback to the user during a biometric authorisation process to aid the user in correct use of the biometric sensor.

6. A biometric authorised smartcard as claimed in claim 3, wherein the biometric sensor is a fingerprint sensor and during use of the fingerprint sensor the graphical user interface provides feedback on the positioning of the finger relative to the fingerprint sensor and feedback on the pressure being applied to the fingerprint sensor.

7. A biometric authorised smartcard as claimed in claim 1, wherein the biometric sensor is a fingerprint sensor and during use of the fingerprint sensor the graphical user interface provides at least one of feedback on the positioning of the finger relative to the fingerprint sensor and feedback on the pressure being applied to the fingerprint sensor.

8. A biometric authorised smartcard as claimed in claim 4, wherein the smartcard is arranged to enrol an authorised user by obtaining biometric data via the biometric sensor in order to avoid any need for communication of the biometric data outside of the smartcard.

9. A biometric authorised smartcard as claimed in claim 1, wherein the graphical user interface is an LED or LCD display.

10. A biometric authorised smartcard as claimed in claim 9, wherein the graphical user interface has a height of about 5 mm and a width of 15-35 mm.

11. A biometric authorised smartcard as claimed in claim 9, wherein the smartcard has the same size as a conventional bank card and the graphical user interface is located on the face of the smartcard where the bank card numbers are conventionally located.

12. A biometric authorised smartcard as claimed in claim 5, wherein the interaction with the biometric sensor requires confirmation of the identity of the user via biometric authorisation before there is any display of information designated as secure information.

13. A biometric authorised smartcard as claimed in claim 1, comprising: an accelerometer for sensing movements of the device, wherein the control system is arranged to identify movements of the smartcard based on the output of the accelerometer, and wherein the information displayed on the graphical user interface may be accessed by or controlled by a combination of one or more action(s) detected via the biometric sensor as well as a movement sensed by the accelerometer.

14. A biometric authorised smartcard as claimed in claim 5, wherein the information displayed via the graphical user interface further includes information relating to protected features of the smartcard, and wherein such information is only displayed after a biometric authorisation confirms that the user is an authorised user.

15. A biometric authorised smartcard as claimed in claim 5, wherein the smartcard is a bank card used in financial transactions and one or more of the card number(s) or parts thereof are not visible on the smartcard except when displayed via the graphical user interface.

16. A biometric authorised smartcard as claimed in claim 15 wherein the one or more of the card number(s) or parts thereof are displayed only after biometric authorisation confirms that the user is an authorised user.

17. A biometric authorised smartcard as claimed in claim 14, wherein the smartcard is any one of: an access card, a credit card, a debit card, a pre-pay card, a loyalty card, or an identity card.

18. A method for controlling a biometric authorised smartcard, the smartcard comprising: a biometric sensor; a control system for controlling operation of the smartcard;
and a graphical user interface for displaying alphanumeric information to a user of the card; wherein the method includes:
controlling access to one or more protected feature(s) of the smartcard by identifying authorised users via the biometric sensor; and
displaying information on the graphical user interface in response to interaction of the user with the biometric sensor, wherein the information displayed includes information for guiding the user in relation to the use of the biometric sensor.

19. A method as claimed in claim 18, comprising using the graphical user interface to display information to guide enrolment of a user via the biometric sensor and/or to aid the interaction of the user with the biometric sensor during biometric authorisation after enrolment.

20. A computer programme product comprising instructions that, when executed on a control system in a smartcard as claimed in claim 1, will cause the control system to: control access to one or more protected feature(s) of the smartcard by identifying authorised users via the biometric sensor; and to display information on the graphical user interface in response to interaction of the user with the biometric sensor, wherein the information displayed includes information for guiding the user in relation to the use of the biometric sensor.
